(19) United States
(12) Patent Application Publication
(10) Pub. No.: US 2009/0307722 A1
(43) Pub. Date: Dec. 10, 2009

(54) SYSTEM TO DELIVER TARGETED ADVERTISEMENTS IN A LIVE VIDEO STREAM

(75) Inventor: Jesse Ernest Gross, Stanford, CA (US)

Correspondence Address: Jesse Gross, 25 Farrwood Road, Windham, NH, 03087, US

(73) Assignee: Jesse Ernest Gross, Windham, NH (US)

(21) Appl. No.: 12/331,448

(22) Filed: Dec. 10, 2008

Related U.S. Application Data
(60) Provisional application No. 61/012,463, filed on Dec. 10, 2007.

(51) Int. Cl. H04N 7/025

(52) U.S. Cl. 725/34; 725/35

(57) ABSTRACT

A system for inserting video advertisements into a video stream that does not require the inserted video advertisements to be determined at the time of the creation of the video stream. The choice of advertisement to insert is controlled by a targeting mechanism that can use any number of factors to decide which advertisement is displayed. These factors can include characteristics that are specific to individual users. The system is capable of operating over a delivery mechanism where bandwidth must be conserved, such as the Internet.

### CROSS-REFERENCE TO RELATED APPLICATIONS

This application claims the benefit of provisional patent application Ser. No. 61/012,463, filed 2007 Dec. 10 by the present inventor, which is incorporated by reference.

### FEDERALLY SPONSORED RESEARCH

Not Applicable

### SEQUENCE LISTING OR PROGRAM

Not Applicable

### BACKGROUND

1. Field of Invention

This invention relates to the delivery of advertising, specifically to advertisements that are inserted into a video stream.

2. Prior Art

Owing to the fact that technical advances that made large scale online live video streaming possible have only recently occurred, most of the related literature is from cable broadcast systems. These systems have the same goal: to deliver targeted advertisements transparently to end-users as a part of the video stream. In addition, many modern cable systems are superficially similar to the Internet. These systems typically consist of a head-end which creates the video stream, a cable set top box, which often contains sophisticated processing elements and can be programmed, and a digital distribution network. However, while these systems resemble the invention in some ways, due to the differences between the cable system and the Internet, the existing patents cannot be considered enabling. Perhaps the most significant difference is the disparity in bandwidth. Using current technology, a single cable channel can easily support 30 Mbs of bandwidth, compared to 768 Kbs from a typical DSL connection that an end user might have. Thus there is a factor of approximately 40× in the available bandwidth from a single cable channel. A system, such as that detailed in U.S. Pat. No. 7,152,237 (issued to Flickinger et al on Dec. 19, 2006), which states that a “channel may comprise 6 MHz bandwidth and may carry nothing but ads” is completely infeasible on the Internet.

Other systems, which are well suited to the Internet, are not able to handle live video streams. U.S. Pat. No. 7,206,854 (issued to Kauffman et al on Apr. 17, 2007) enables advertisements to be inserted into the video stream, however, “as a result of the time delay associated with the advertisement, the remainder of the multimedia file must be cached then played out until the stream is complete.” Thus any live stream that utilizes this method is no longer live after the display of an advertisement.

Finally, U.S. Pat. No. 7,149,958 “decouples” (issued to Landsman et al on Dec. 12, 2006) advertising content from a web page such that a web page, enabling advertisements to be downloaded “in a manner transparent to a user situated at the browser, and subsequently displayed, by that browser on an interstitial basis.” This creates a user experience similar to that enabled by the invention in that it is a seamless background process. However, the patent assumes a more traditional form of advertising and is infeasible for video, which has significantly higher demands in terms of data transfer and has precise timing and synchronization requirements. Without significant additional experimentation, the description of the patent would not be sufficient to implement the ideal system presented in the description of the invention.

### DRAWINGS

FIG. 1 is a diagram representing the preferred embodiment of the system, as seen by the end user.

FIG. 2 is a flow chart representing the control path needed to support the operation of the preferred embodiment of the system.

FIG. 3 is a diagram representing the data path needed to support the operation of the preferred embodiment of the system.

### DETAILED DESCRIPTION

### Preferred Embodiment

The description of the preferred embodiment of the system should not be construed to limit the invention to this embodiment. It provides only an example of one of the potential embodiments to enable a person of ordinary skill in the art to make and use the invention.

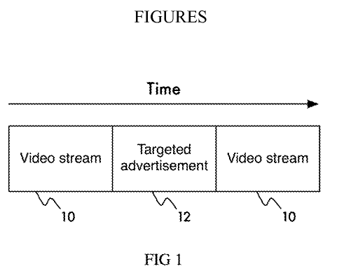

As shown in FIG. 1, the system enables the delivery of advertisements 12 that are targeted to the viewer of a live video stream 10. These may be preroll, interstitial, or postroll advertisements that are inserted into segments of the desired content. These advertisements 12 are seamlessly integrated into the video stream, as in traditional broadcast television. However, unlike traditional broadcast television, the advertisements 12 can be individually targeted to viewers.

The live video stream 10 might be from an event that is broadcast in real-time, such as a sporting event. It could also be the broadcast of such an event in the future. Furthermore, in this context, the live video stream 10 should not be construed to be exclusively content that is created in real-time during the event. The video stream 10 can be created by any means, including content with extensive editing or computer generated imagery. The mechanism used for creation of the video is not important, but rather the mechanism of delivery to the end user. For the purposes of this document, live video stream 10 should be construed to mean any video that is delivered to the end user using a mechanism that could be employed for the transmission of real-time video content.

Targeted advertisements 12 are segments of content that are inserted into the video stream based on the identity of the end user. Matching of advertisements to users can be accomplished through a variety of methods, including user purchasing history, geographical location, demographics, etc. More than one user may see the same advertisements, but targeting enables the definition of multiple classes of users that see different advertisements. While the delivery of commercial advertisements appears to be the best mode for this invention, the advertisements 12 could in fact be any type of video that is targeted to the end user, regardless of the actual content.

A common delivery mechanism for the system might be the Internet. However, it could also be implemented using a variety of other delivery mechanisms, including, but not limited to, cable or satellite television.

The user's playback environment 32 is capable of being programmed to execute certain sequences of instructions. This allows the video stream to be tailored to deliver targeted advertisements. Examples of programmable playback environments 32 include, but are not limited to, Adobe Flash Player on a computer and cable set top boxes for televisions.

The system consists of several components: the live video delivery system 34, a repository of video advertisements 28, an advertising targeting system 30, and the user's playback environment 32. The final system may be embodied by combining these components or breaking them down into more independent pieces for technical or business reasons without changing their essential functions. The system is made operational through these components and the communication between them.

The live video system 34 is the mechanism through which the desired content 10 is delivered to the viewer. Embodiments range from a simple system in which there is a direct connection between the originator of the content and the end user to complex distribution networks. Distribution networks include systems such as content distribution networks on the Internet and satellite broadcast systems for television. The live video system 34 is akin to current systems for delivering video content. However, unlike existing technologies, the live video system 34 is not used as the primary mechanism for delivering advertisements. The live video system 34 delivers the same content to all users watching a particular program and as such by itself is incapable of delivering targeted advertisements 12.

The repository of video advertisements 28 is a system containing all of the possible advertisements that may be seen by the end user. Generally, each user will see only a subset of the advertisements that are contained in the repository. However, embodiments of the system where all users see all of the advertisements are conceivable. In this case, the system is not used for targeting, but is instead used for flexibility in choice of advertisements, which might not be known at the time of content production. However, the essential elements remain the same. These advertisements are created ahead of time and are transferred for viewing to the end user when requested by the playback software 32. The mechanism for the transfer is typically not the same as that used for the live video stream 10. While the live video stream 10 may be optimized for delivery of real-time video, the repository of video advertisements 28 can transfer data without real-time requirements. As a result, a less demanding protocol may be utilized. In addition, without the real-time requirements, the video can be of higher quality since there is more flexibility for retries in the event of errors or distribution network problems. An example of a simple repository of video advertisements is a normal web server.

The advertising targeting system 30 is a mechanism for matching users to particular subsets of advertisements stored in the repository of video advertisements 28. It can make this selection based any profile data assembled about the user, such as history, geographical location, or demographics. This matching can be achieved using server side databases, information submitted by the user's client, or a combination of the two. When the user's playback environment 32 needs to display an advertisement, it sends a request to the advertising targeting system 30, which responds with the location of the appropriate advertisement on the repository of video advertisements 28.

The user's playback environment 32 enables seamless merging of the live video stream 10 and the appropriate targeted advertisements 12. This is enabled though the use of a programmable player, such as Adobe Flash Player. The environment 32 is responsible for displaying both the video stream 10 and advertisements 12 as well as communicating with the advertising targeting server 30 to select the appropriate advertisements to display.

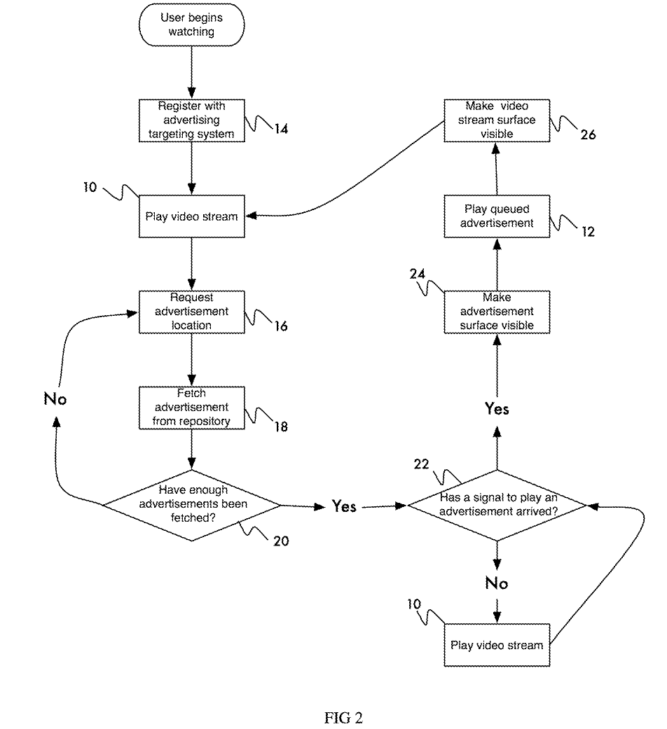

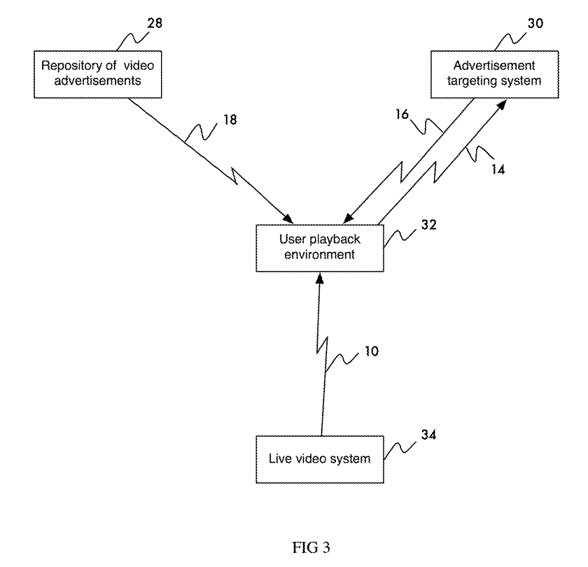

The operation of the system is depicted in FIG. 2 and FIG. 3. When a user wishes to view content utilizing the system, his player is initialized with the addresses of all other components in the system. This can be achieved by navigating to a webpage containing all necessary initialization information. Upon activation, the player 32 initiates a connection 14 to the advertising targeting server 30 and potentially provides information about the user, such as a username. The targeting server 30 uses this and any other available data sources to match the user to appropriate advertisements. In response, the server returns an identifier, which is submitted by the player 32 with all future communication. After registering 14 with the targeting server 30, the player requests the video stream 10 from the live video system 34 and begins to display it to the end user. To anticipate the next advertisement 12, the player environment 32 contacts the targeting server 30 again and requests 16 the location of an advertisement 12. The server 30 responds 16 with the location of an advertisement on the repository of video advertisements 28 based on the best match with the user. The user's player 32 immediately begins fetching 18 this advertisement 12 but does not play it. Depending upon network conditions, the player may fetch additional advertisements in this manner. Once the player has a sufficient number of advertisements stored 20, it continues playing the video stream 10 but stops fetching 18 advertisements 12.

At a time determined by the content broadcaster, a signal to display an advertisement 12 is sent to the player. This signal can be sent by a variety of methods. Examples of methods to send the signal include in-band in the video stream (to ensure that everyone sees the advertisement at the same point in the video stream), out-of-band (ensuring that everyone sees the advertisement at the same time), and a timer within the player. Once the signal is received 22, the player 32 begins playback of the first queued advertisement 12. At the end of the advertisement, the player switches back to the original video stream 10. While the video stream continues to play, the playback environment contacts 16 the advertising targeting server 30 to request another advertisement and the cycle continues until the viewer stops watching the video stream.

To enhance the illusion of a single continuous stream, the player 32 may use a software trick to create two video “surfaces,” each of which is effectively a video player. One surface contains the live video stream 10 and the other the desired advertisement 12. Both surfaces should be located in the same position on the user's display device. By making only one of the two surfaces visible at any given time and muting the corresponding sound as appropriate, it is possible to achieve the effect of a cut between the two video streams, as viewers are accustomed to in broadcast television. At the end of the advertisement 12, an analogous cut is made back to the original live video stream 10. Therefore, the process of displaying an advertisement is to make the advertisement surface visible and the video invisible 24. Once the advertisement is over, the reverse happens and the video surface is made visible while the advertisement is invisible 26. This method of switching between video streams is only a single potential embodiment. It is currently the best mode for many situations on the Internet; however, other embodiments of the system may permit direct seamless switching between video streams or require additional work as is appropriate to the user playback environment 32.

Through the use of the described background fetch and swap mechanism, the viewer experiences a seamless transition between the video stream 10 and advertisements 12 akin to standard television. However, unlike television, the advertisements can be targeted to each user. Each user can receive a different advertisement and still enjoy a flawless viewing experience, with the only constraint being that the advertisements 12 must be the same length.

As a person skilled in the art will recognize from the preceding detailed description and figures, modifications can be made to the preferred embodiment without departing from the essential function of the invention defined in the following claims.

I claim:

1. Apparatus for use in transporting video via a delivery mechanism, the apparatus comprising: a video player capable of displaying video to a viewer, a plurality of video objects which may be displayed on said video player, one or more inserted video objects selected from the group of video objects and a targeting mechanism used to chose inserted video objects wherein video player displays inserted video objects before or after the display of other video objects, said inserted video object is not required to be predetermined at the time of creation of other video objects, and wherein display of the inserted video object is to be controlled by the targeting mechanism.

2. The apparatus in claim 1 wherein the video player contains means for rendering video objects in a manner such that the transition between video objects appears seamless to the viewer.

3. The apparatus in claim 2 wherein the inserted video object is an inserted advertisement.

4. The apparatus in claim 3 wherein the inserted advertisement is an interstitial advertisement.

5. The apparatus in claim 4 wherein said delivery and targeting mechanisms contain means for different viewers to see different inserted advertisements.

6. The apparatus in claim 5 wherein the targeting mechanism is principally controlled by demographic information when deciding which advertisement to insert.

7. The apparatus in claim 6 wherein the delivery mechanism is the Internet.

8. The apparatus in claim 7 wherein the delivery mechanism contains means for ensuring that the delay between the event and viewing is small enough to be considered real-time.
